(19) United States
(12) Patent Application Publication
(10) Pub. No.: US 2024/0314644 A1
(43) Pub. Date: Sep. 19, 2024

(54) SYSTEMS AND METHODS FOR FALSE CONGESTION AVOIDANCE

(71) Applicant: Meta Platforms Technologies, LLC, Menlo Park, CA (US)

(72) Inventors: Curt Wong, Bellevue, WA (US); Qi Qu, Redmond, WA (US); Zhu Ji, Cupertino, CA (US); Jimin Liu, Bellevue, WA (US)

(21) Appl. No.: 18/120,723

(22) Filed: Mar. 13, 2023

(51) Int. Cl. H04W 36/00; H04W 36/08

(52) U.S. Cl. CPC H04W 36/0011; H04W 36/08

(57) ABSTRACT

Disclosed herein are systems and methods related to false congestion avoidance during handover events. The systems and methods can include a wireless communications interface and one or more processors. The system can detect an event corresponding to a transition of at least one wireless connection, from being between the wireless communications interface and a first network element, to being between the wireless communications interface and a second network element and transmit, via the wireless communication interface to a remote device, a signal comprising at least one of: an indication of the event or an indication to avoid a congestion mitigation operation.

### FIELD OF DISCLOSURE

The present disclosure is generally related to facilitating wireless communication, including but not limited to systems and methods for false congestion avoidance.

### BACKGROUND

Developments in computing devices and communication devices have prompted growth in wearable technology. Wearable devices may integrate various components in a compact form, such that the wearable devices can be portable yet perform complex processes. For example, a wearable device may be a smart watch that may access content over the network, and may control or communicate with other computing devices, etc.

### SUMMARY

Various implementations disclosed herein are related to a device. The device can include a wireless communications interface. The device can include one or more processors. The one or more processors can detect an event corresponding to a transition of at least one wireless connection, from being between the wireless communications interface and a first network element, to being between the wireless communications interface and a second network element. The one or more processors can transmit, via the wireless communication interface to a remote device, a signal comprising at least one of: an indication of the event or an indication to avoid a congestion mitigation operation.

In some implementations, the one or more processors can transmit, via a transmitter to the remote device, an indication to maintain one or more rates of data transmission between the wireless communications interface and the remote device, responsive to the detection of the event. In some implementations, the signal can include congestion feedback data. In some implementations, the indication can cause the remote device to maintain one or more rates of data transmission.

In some implementations, the remote device can be a server. The server can execute an application to generate data packets. The server can transmit, to the wireless communications interface, the data packets at a first rate of data transmission, in the absence of a congestion event. In some implementations, the network elements are cells or base stations of a cellular network. In some implementations, the one or more processors can detect the event responsive to an indication from a modem of the wireless communications interface, wherein the indication is indicative of a handover event or a non-congestion event.

In some implementations, the one or more processors can execute a predetermined protocol layer. The one or more processors can generate, at the predetermined protocol layer, the signal. In some implementations, the one or more processors can transmit via a transceiver the signal according to a predetermined communication protocol, the predetermined communication protocol providing for transmitting the signal via at least one packet, an indication of the transition, to the remote server. The predetermined communication protocol can cause the remote device to determine or implement a response to the transition.

In some implementations, the one or more processors can transmit the signal according to a predetermined communication protocol. The predetermined communication protocol can provide for transmitting the signal via an acknowledgement of receipt of one or more data packets from the remote device, an indication of the transition, to the remote server. The predetermined communication protocol can cause the remote device to determine or implement a response to the transition. In some implementations, the event comprises a handover event between a target cell and a source cell.

Various implementations disclosed herein are related to a method. The method can include detecting, by a device, an event corresponding to a transition of at least one wireless connection, from being between a wireless communications interface of the device and a first network element, to being between the wireless communications interface and a second network element. The method can include transmitting, by the device via the wireless communications interface, to a remote device, a signal comprising at least one of: an indication of the event or an indication to avoid a congestion mitigation operation.

In some implementations, the method can include transmitting, to the remote device, an indication to maintain one or more rate of data transmission between the wireless communication interface and the remote device, responsive to the detection of the event. In some implementations, the signal indicating the event can include congestion feedback data.

In some implementations, the method can include executing, by the remote device, an application to generate data packets. The method can include transmitting, to the wireless communications interface, the data packets at a first rate of data transmission, in the absence of a congestion event.

In some implementations, the method can include detecting, by the device, the event responsive to an indication from a modem of the wireless communications interface wherein the indication is indicative of a handover event or a non-congestion event. In some implementations, the method can include executing, by the device, a predetermined protocol layer. The method can include generating, by the predetermined protocol layer, the signal.

In some implementations, the method can include transmitting, by the device, the signal according to a predetermined communication protocol. The predetermined communication protocol can provide for transmitting the signal via at least one packet, an indication of the transition, to the remote device. The predetermined communication protocol can cause the remote device to determine or implement a response to the transition.

In some implementations, the method can include transmitting, by the device, the signal according to a predetermined communication protocol. The predetermined communication protocol can provide for transmitting the signal via an acknowledgement of receipt of one or more data packets from the remoted device, an indication of the transition, to the remote device. The predetermined communication protocol can cause the remote device to determine or implement a response to the transition.

Various implementations disclosed herein are related to a non-transitory computer readable medium storing program instructions. The program instructions can cause at least one processor of a device to detect an event corresponding to a transition of at least one wireless connection, from being between the wireless communications interface and a first network element, to being between the wireless communications interface and a second network element. The program instructions can cause at least one processor of a device to transmit, via the wireless communication interface to a remote device, a signal comprising at least one of: an indication of the event or an indication to avoid a congestion mitigation operation.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram showing example components of a base station and a user equipment, according to an example implementation of the present disclosure.

FIG. 3 is a diagram of a system for false congestion avoidance.

FIG. 4 is a diagram of a handover event, according to an example implementation of the present disclosure.

FIG. 5 is a diagram of a wearable device, according to an example implementation of the present disclosure.

FIG. 6 is flowchart showing a method of false congestion avoidance, according to an example implementation of the present disclosure.

FIG. 7 is a flowchart showing an example method of event detection.

FIG. 8 is a diagram showing a perspective view of a head wearable display, according to an example implementation of the present disclosure.

FIG. 9A is a diagram showing a perspective view of a wearable device including a computing device attached to a cradle, according to an example implementation of the present disclosure.

FIG. 9B is a diagram showing a perspective view of a wearable device including a computing device detached from a cradle, according to an example implementation of the present disclosure.

FIG. 10 is a block diagram showing a computing environment of a wearable device, according to an example implementation of the present disclosure.

FIG. 11 is a diagram of a system environment including wearable devices, according to an example implementation of the present disclosure.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Disclosed herein are implementations related to systems and methods of avoiding congestion-based responses for data communication to a device based on device feedback, including device feedback indicating that a handover of a wireless connection of the device between cells of a cellular network has occurred or is occurring. For example, in a handover, a device may transition from communicating with a first network to communicating with a second network. Communication over a network can experience congestion, latency, interruption, or transitions. Often, a transition can cause latency in communication.

For example, cellular networks can perform handovers as mobile devices, such as user equipment (UE), change in location relative to portions of the cellular network. As a result, metrics that the UE monitors to detect congestion, such as packet arrival times or other latency and/or jitter-related metrics, can increase, such as by about 50-100 ms. In some implementations, the UE may communicate the congestion metric to a source device, such as a server, which may inadvertently cause the source device to perform anti-congestion responses to reduce data communication rates to the UE. Such anti-congestion responses may use 1-2 seconds of time to implement before restoring nominal communication rates, even if the initial delay period resulting from the handover only uses about 50-100 ms. This delay in restoration of nominal rates can result in unnecessarily lower signal quality, signal loss, and/or latency.

Systems and methods in accordance with the present disclosure can mitigate or avoid various such excessive anti-congestion responses by communicating, from the UE to the source device, an indication of the handover. For example, the UE can communicate the indication responsive to detecting or performing or anticipating the handover. For instance, a modem of the UE can indicate to an application layer (e.g., OS/protocol stack framework) that a handover operation is to be performed, being performed and/or has been performed, responsive to which the application layer can transmit a signal to the source device that the handover operation is to be performed, being performed and/or has been performed.

The application layer can transmit the signal as part of a congestion feedback signal, which can avoid the trigger to lower network data traffic or communication demands between the UE and the source device. For example, the signal can be transmitted using L4 congestion communication channels/protocols such as real-time transport communication protocol (RTCP), transport wide congestion control (TWCC) or quick UDP internet connections (QUIC). The source device can delay or otherwise avoid performing anti-congestion responses, such as for a predetermined period subsequent to receiving the signal, such that nominal communication rates can be maintained during the handover or immediately or nearly immediately after the handover. This can enable the quality of the user experience at the UE to be maintained (e.g., with only a minimal decrease in quality during the handover period itself), since false congestion detections can be avoided and thus anti-congestion responses can be avoided.

Although various implementations disclosed herein are provided with respect to wearable devices and cellular, principles disclosed herein can be applied to any other type of devices such as handheld, mobile or small form factor devices (e.g., smart phones, tablet computers, laptops, etc.) as well as various networks, including but not limited to mesh networks, that may implement handover operations across portions of the networks.

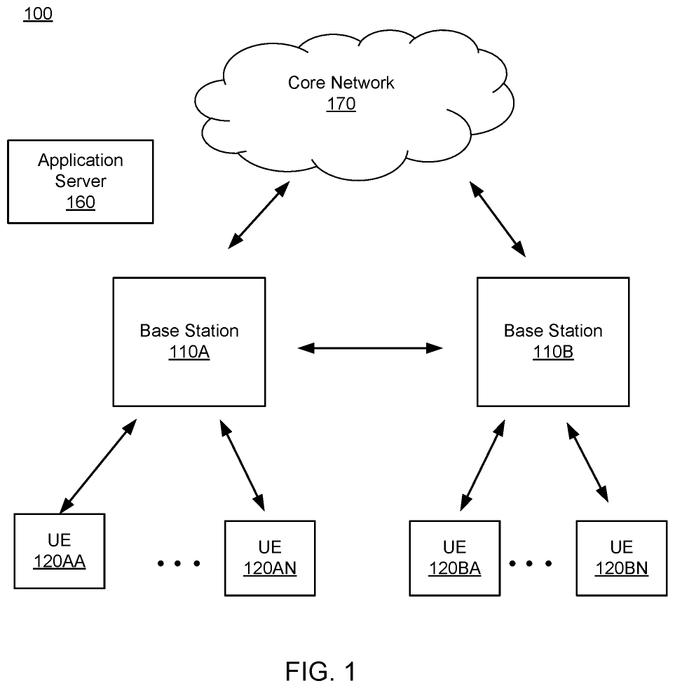

FIG. 1 illustrates an example wireless communication system 100. The wireless communication system 100 may include base stations 110A, 110B (also referred to as “wireless communication nodes 110” or “stations 110”) and user equipments (UEs) 120AA . . . 120AN, 120BA . . . 120BN (also referred to as “wireless communication devices 120” or “terminal devices 120”). The wireless communication link may be a cellular communication link conforming to 3G, 4G, 5G or other cellular communication protocols. In one example, the wireless communication link supports, employs or is based on an orthogonal frequency division multiple access (OFDMA). In one aspect, the UEs 120AA . . . 120AN are located within a geographical boundary with respect to the base station 110A, and may communicate with or through the base station 110A. Similarly, the UEs 120BA . . . 120BN are located within a geographical boundary with respect to the base station 110B, and may communicate with or through the base station 110B. A network between UEs 120 and the base stations 110 may be referred to as radio access network (RAN). In some implementations, the wireless communication system 100 includes more, fewer, or different number of base stations 110 than shown in FIG. 1.

In some implementations, the UE 120 may be a user device such as a mobile phone, a smart phone, a personal digital assistant (PDA), tablet, laptop computer, wearable computing device (e.g., head mounted display, smart watch), etc. Each UE 120 may communicate with the base station 110 through a corresponding communication link. For example, the UE 120 may transmit data to a base station 110 through a wireless communication link (e.g., 3G, 4G, 5G or other cellular communication link), and/or receive data from the base station 110 through the wireless communication link (e.g., 3G, 4G, 5G or other cellular communication link). Example data may include audio data, image data, text, etc. Communication or transmission of data by the UE 120 to the base station 110 may be referred to as an uplink communication. Communication or reception of data by the UE 120 from the base station 110 may be referred to as a downlink communication.

In some implementations, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations.

In some implementations, the wireless communication system 100 includes a core network 170. The core network 170 may be a component or an aggregation of multiple components that ensures reliable and secure connectivity to the network for UEs 120. The core network 170 may be communicatively coupled to one or more base stations 110A, 110B through a communication link. A communication link between the core network 170 and a base station 110 may be a wireless communication link (e.g., 3G, 4G, 5G or other cellular communication link) or a wired communication link (e.g., Ethernet, optical communication link, etc.). In some implementations, the core network 170 includes user plane function (UPF), access and mobility management function (AMF), policy control function (PCF), etc. The UPF may perform packet routing and forwarding, packet inspection, quality of service (QOS) handling, and provide external protocol data unit (PDU) session for interconnecting data network (DN). The AMF may perform registration management, reachability management, connection management, etc. The PCF may help operators (or operating devices) to easily create and seamlessly deploy policies in a wireless network. The core network 170 may include additional components for managing or controlling operations of the wireless network. In one aspect, the core network 170 may receive a message to perform a network congestion control, and perform the requested network congestion control. For example, the core network 170 may receive explicit congestion notification (ECN) from a base station 110 and/or a UE 120, and perform a network congestion control according to the ECN. For example, the core network 170 may adjust or control an amount of data generated, in response to the ECN. Additionally or alternatively, the core network 170 may adjust or control an amount of data transmitted and/or received, in response to the ECN.

In some implementations, the wireless communication system 100 includes an application server 160. The application server 160 may be a component or a device that generates, manages, or provides content data. The application server 160 may be communicatively coupled to one or more base stations 110A, 110B through a communication link. A communication link between an application server 160 and a base station 110 may be a wireless communication link (e.g., 3G, 4G, 5G or other cellular communication link) or a wired communication link (e.g., Ethernet, optical communication link, etc.). In one aspect, an application server 160 may receive a request for data from a UE 120 through a base station 110, and can provide the requested data to the UE 120 through the base station 110. In one aspect, an application server 160 may receive a message to perform a network congestion control, and perform the requested network congestion control. For example, the application server 160 may receive explicit congestion notification (ECN) from a base station 110, a UE 120, or a core network 170, and perform a network congestion control according to the ECN. For example, the application server 160 may adjust or control an amount of data generated, in response to the ECN. Additionally or alternatively, the application server 160 may adjust or control an amount of data transmitted and/or received, in response to the ECN.

In some implementations, communication among the base stations 110, the UEs 120, application server 160, and/or the core network 170 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, among other layers.

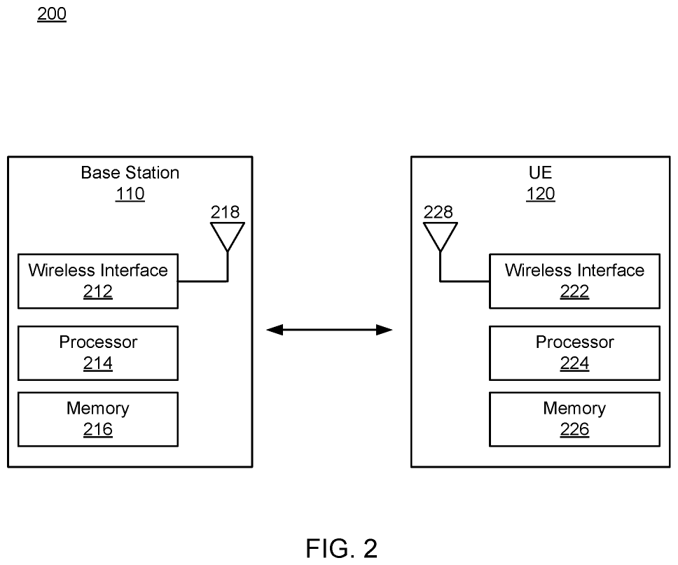

FIG. 2 is a diagram showing example components of a base station 110 and a user equipment 120, according to an example implementation of the present disclosure. In some implementations, the UE 120 includes a wireless interface 222, a processor 224, a memory device 226, and one or more antennas 228. These components may be embodied as hardware, software, firmware, or a combination thereof. In some implementations, the UE 120 includes more, fewer, or different components than shown in FIG. 2. For example, the UE 120 may include an electronic display and/or an input device. For example, the UE 120 may include additional antennas 228 and wireless interfaces 222 than shown in FIG. 2.

The antenna 228 may be a component that receives a radio frequency (RF) signal and/or transmits a RF signal through a wireless medium. The RF signal may be at a frequency between 200 MHz to 100 GHz. The RF signal may have packets, symbols, or frames corresponding to data for communication. The antenna 228 may be a dipole antenna, a patch antenna, a ring antenna, or any suitable antenna for wireless communication. In one aspect, a single antenna 228 is utilized for both transmitting a RF signal and receiving a RF signal. In one aspect, different antennas 228 are utilized for transmitting the RF signal and receiving the RF signal. In one aspect, multiple antennas 228 are utilized to support multiple-in, multiple-out (MIMO) communication.

The wireless interface 222 includes or is embodied as a transceiver for transmitting and receiving RF signals through one or more antennas 228. The wireless interface 222 may communicate with a wireless interface 212 of the base station 110 through a wireless communication link. In one configuration, the wireless interface 222 is coupled to one or more antennas 228. In one aspect, the wireless interface 222 may receive the RF signal at the RF frequency received through an antenna 228, and downconvert the RF signal to a baseband frequency (e.g., 0˜1 GHz). The wireless interface 222 may provide the downconverted signal to the processor 224. In one aspect, the wireless interface 222 may receive a baseband signal for transmission at a baseband frequency from the processor 224, and upconvert the baseband signal to generate a RF signal. The wireless interface 222 may transmit the RF signal through the antenna 228.

The processor 224 is a component that processes data. The processor 224 may be embodied as field programmable gate array (FPGA), application specific integrated circuit (ASIC), a logic circuit, etc. The processor 224 may obtain instructions from the memory device 226, and execute the instructions. In one aspect, the processor 224 may receive downconverted data at the baseband frequency from the wireless interface 222, and decode or process the downconverted data. For example, the processor 224 may generate audio data or image data according to the downconverted data, and present an audio indicated by the audio data and/or an image indicated by the image data to a user of the UE 120. In one aspect, the processor 224 may generate or obtain data for transmission at the baseband frequency, and encode or process the data. For example, the processor 224 may encode or process image data or audio data at the baseband frequency, and provide the encoded or processed data to the wireless interface 222 for transmission.

The memory device 226 is a component that stores data. The memory device 226 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 226 may be embodied as a non-transitory computer readable medium storing instructions executable by the processor 224 to perform various functions of the UE 120 disclosed herein. In some implementations, the memory device 226 and the processor 224 are integrated as a single component.

In some implementations, the base station 110 includes a wireless interface 212, a processor 214, a memory device 216, and one or more antennas 218. These components may be embodied as hardware, software, firmware, or a combination thereof. In some implementations, the base station 210 includes more, fewer, or different components than shown in FIG. 2. For example, the base station 210 may include an electronic display and/or an input device. For example, the base station 210 may include additional antennas 218 and wireless interfaces 212 than shown in FIG. 2.

The antenna 218 may be a component that receives a radio frequency (RF) signal and/or transmits a RF signal through a wireless medium. The antenna 218 may be a dipole antenna, a patch antenna, a ring antenna, or any suitable antenna for wireless communication. In one aspect, a single antenna 218 is utilized for both transmitting a RF signal and receiving a RF signal. In one aspect, different antennas 218 are utilized for transmitting the RF signal and receiving the RF signal. In one aspect, multiple antennas 218 are utilized to support multiple-in, multiple-out (MIMO) communication.

The wireless interface 212 includes or is embodied as a transceiver for transmitting and receiving RF signals through one or more antennas 218. The wireless interface 212 may communicate with a wireless interface 222 of the UE 120 through a wireless communication link. In one configuration, the wireless interface 212 is coupled to one or more antennas 218. In one aspect, the wireless interface 212 may receive the RF signal at the RF frequency received through antenna 218, and downconvert the RF signal to a baseband frequency (e.g., 0˜1 GHz). The wireless interface 212 may provide the downconverted signal to the processor 214. In one aspect, the wireless interface 212 may receive a baseband signal for transmission at a baseband frequency from the processor 214, and upconvert the baseband signal to generate a RF signal. The wireless interface 212 may transmit the RF signal through the antenna 218.

The processor 214 is a component that processes data. The processor 214 may be embodied as FPGA, ASIC, a logic circuit, etc. The processor 214 may obtain instructions from the memory device 216, and execute the instructions. In one aspect, the processor 214 may receive downconverted data at the baseband frequency from the wireless interface 212, and decode or process the downconverted data. For example, the processor 214 may generate audio data or image data according to the downconverted data. In one aspect, the processor 214 may generate or obtain data for transmission at the baseband frequency, and encode or process the data. For example, the processor 214 may encode or process image data or audio data at the baseband frequency, and provide the encoded or processed data to the wireless interface 212 for transmission. In one aspect, the processor 214 may set, assign, schedule, or allocate communication resources for different UEs 120. For example, the processor 214 may set different modulation schemes, time slots, channels, frequency bands, etc. for UEs 120 to avoid interference. The processor 214 may generate data (or UL CGs) indicating configuration of communication resources, and provide the data (or UL CGs) to the wireless interface 212 for transmission to the UEs 120.

The memory device 216 is a component that stores data. The memory device 216 may be embodied as RAM, flash memory, ROM, EPROM, EEPROM, registers, a hard disk, a removable disk, a CD-ROM, or any device capable for storing data. The memory device 216 may be embodied as a non-transitory computer readable medium storing instructions executable by the processor 214 to perform various functions of the base station 110 disclosed herein. In some implementations, the memory device 216 and the processor 214 are integrated as a single component.

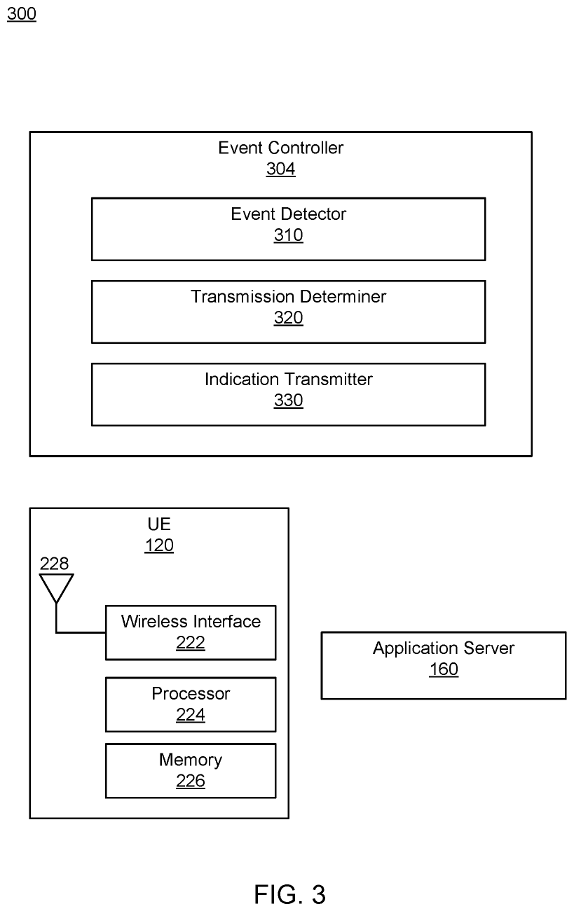

FIG. 3 is a diagram of a system 300 for false congestion avoidance. The system 300 can include an event controller 304, according to an example implementation of the present disclosure. The event controller 304 may be embodied by any of various devices and systems described herein, such as the base station 110, one or more network nodes of a core/cellular network (e.g., core network 170), a client device, such as UE 120, a remote device, such as application server 160, or various combinations thereof. The event controller 304 may be implemented as FPGA, ASIC, or any logic circuit. The event controller 304 may be implemented as part of the processor 214, the processor 224, or an external computing device. In some implementations, the event controller 304 includes an event detector 310, transmission determiner 320, and an indication transmitter 330. These components may operate together to determine a handover event or a non-congestion event. In some implementations, the event controller 304 includes more, fewer, or different components than shown in FIG. 3.

In some implementations, the event detector 310 can detect an event. In one aspect, the event detector 310 can detect one or more types of network events. Examples of a type of network event can include a handover, a non-congestion event, an uplink congestion, a downlink congestion, or any combination thereof. A handover can result in a transition of a device (e.g., UE 120) communicating from a first network element (e.g., first cell or base station) to communicating with a second network element (e.g., second cell or base station). For example, the core network 170 can cause, responsive to detecting that the UE 120 is out of a target range of the first network element, the second network element to establish a communication link between the UE 120 and the application server 160 (and can cause the first network element to discontinue a communication link between the application server 160 and the UE 120 via the first network element). A handover can be, for example, an N2 or an S1 based handover, in which the handover of the UE 120 between base station 110 is coordinated by the core network 170. A handover can exist whenever a wireless connection or communication changes from being between a first wireless communications interface (e.g. wireless interface 222) and a first network element (e.g., a network element 416 or a network element 418 described herein), to a second network element (e.g., a network element 416 or a network element 418 described herein, different from the first network element). In some implementations, a handover can cause a delay of 50-100 ms.

The event detector 310 may detect a handover from a first network (e.g., from a first/source cell or radio access network) to a second network (e.g., to a second/target cell or radio access network). The event detector can detect an event corresponding to a transition of at least one wireless connection, from being between the wireless communications interface and a first network element (e.g., first cell or base station), to being between the wireless communications interface and a second network element (e.g., second cell or base station). The event detector 310 may, in some implementations, determine that a handover has occurred or is occurring by the UE 120 acknowledging a change in a network. For example, the event detector 310 can detect a change in a network node, configuration, or location, which can indicate a transition or handover from a first network element to a second network element.

The event detector 310 may detect a handover by a change in the wireless connection, such as a delay of data packet transmission (e.g., a delay that meets at least one of a minimum threshold or a maximum threshold indicative of handover) or a change in data packet types of the wireless connection (e.g., a change of header information representing a network element from which the data packets are received). In some implementations, the event detector 310 can detect the event responsive to an indication from a modem of the wireless communications interface, wherein the indication is a signal corresponding to a non-congestion event (e.g., a handover). For example, a modem or modem application interface (API) of the UE 120 can indicate to a protocol stack framework of the UE 120 that a handover has occurred. In some implementations, the event detector 310 receives a message indicating a type event from another device (e.g., UE 120, core network 170, application server 160, or another communication device), and may determine the type of the event as indicated by the received message. In one approach, the event detector 310 may monitor an amount of unsuccessful transmissions/receptions, and can determine an event corresponding to the amount of unsuccessful transmissions/receptions. For example, a handover event may have less unsuccessful transmissions/receptions than an actual congestion event.

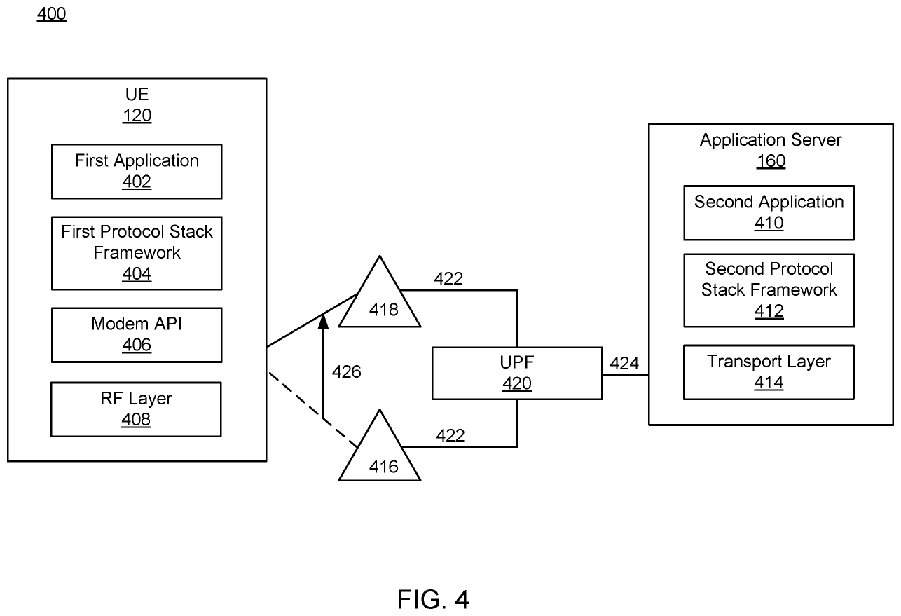

The event detector 310 can communicate with at least the components of the event controller 304. In some implementations, responsive to a detection of an event by the event detector 310, the transmission determiner 320 can coordinate a signal indicating the event (e.g., second signal) for transmission to the application server 160, network elements 416 or 418 (as described with reference to FIG. 4), or other components of the system 300.

The transmission determiner 320 can determine data to include in a second signal for transmission by the event controller 304. The second signal for transmission can be a signal indicating the event. For example, responsive to detection of an event by the event detector 310, the transmission determiner 320 can create instructions to maintain or prioritize parameters of the wireless communication (e.g., a speed or rate of data transmission). For example, the transmission determiner 320 can generate data packets to instruct the system 300 to maintain (e.g., not reduce) a rate of data packet transmission responsive to the detection of a handover.

In some implementations, the transmission determiner 320 can generate data for inclusion within the signal indicating the event. The signal indicating the event can be or include congestion feedback data. The signal can include instructions, code, bits, etc. to change or maintain a second signal, and/or to provide congestion feedback data. For example, the transmission determiner can include within a signal one or more instructions or indications to maintain a speed, frequency, transmission rate, or bandwidth of a second signal. The transmission determiner 320 can determine the instruction(s)/indication(s) to include in the signal responsive to the detection of an event, such as a handover event or a non-congestion condition event.

In some implementations, the transmission determiner 320 can determine the one or more parameters of a signal (communicated through the wireless communication interface of the device/UE 120) by processing a plurality of bits of the wireless communication. For example, the transmission determiner 320 can determine the one or more parameters of the second signal to encode in the signal indicating the event according to respective values of the plurality of bits of the wireless communication. The transmission determiner 320 can include one or more rules, heuristics, models, functions, mappings, algorithms, or other operators that process the plurality of bits to determine the one or more parameters.

The transmission determiner 320 can prevent traffic congestion mitigation actions, responsive to false detection of congestion. A wrongful determination of congestion can result in false congestion mitigations (e.g., anti-congestion responses, congestion mitigation operations). For example, a determination of congestion can cause a slow-down (e.g., decrease in bandwidth or transmission rate) of a wireless signal, latency, or delay. A wrongful determination of congestion can occur as a result of a time-delay from a non-congestion event (e.g., a handover event), a slow-down of data packets being transmitted, or a variation (e.g., in size, headers, periodicity of arrival) of data packet transmission. In some implementations, the signal indicating the event can include instructions to prevent the remote device (e.g., application server 160) from performing anti-congestion responses (e.g., congestion mitigation operations).

As an illustrative example, the event controller 304 can modify the signal indicating the event according to a predetermined communication configuration or a protocol, such as real-time transport control protocol (RTCP) or QUIC. For example, transmission determiner 320 can determine the data to include in the signal. This data can include data packets. The data packets can be of any form, protocol, type, or size. For example, the data packets can be receiver report (RR), sender report (SR), source description items (SDES), end of participation (BYE), or application specific functions (APP). In some implementations, the transmission determiner 320 can modify or encode one or more APP data packets to include information pertaining to the event, such as the type of event or instructions to control the wireless communication responsive to the event. The remote device (e.g., application server 160) can receive the encoded packets and can determine a response, based at least on the event. For example, the application server 160 can receive a data packet within the signal indicating a handover. The application server 160 can, responsive to the receipt, determine to delay or stop anti-congestion responses.

In some implementations, the transmission determiner 320 can configure the signal indicating the event according to a QUIC protocol. For example, the transmission determiner 320 can include within the signal encrypted data packets. The data packets (encrypted or unencrypted) can include information pertaining to an acknowledgement of receipt of one or more data packets from the remote device (e.g., application server 160). In some implementations, the remote device can receive the data packets from the event controller 304 including the acknowledgement of receipt and information pertaining to the event. The remote device can receive the packets and determine a response, based at least on the event. For example, the application server 160 can receive a data packet within the signal indicating a handover. The application server 160 can, responsive to the receipt, determine to delay or stop anti-congestion responses.

The indication transmitter 330 can transmit the signal indicating the event to the remote device (e.g., application server 160) to indicate a handover has occurred or is in the process of occurring. The indication transmitter 330 can transmit, via the wireless communications interface, to a remote device (e.g., application server 160; a second UE 120), a signal including at least one of: an indication of the event or an indication to avoid a congestion mitigation operation. The signal indicating the event can be configured by the transmission determiner 320 to include data or information pertaining to the event. The signal indicating the event can indicate one or more processes to maintain a parameter of the wireless communication. In some implementations, the indication transmitter 330 can transmit, to the remote device, an indication to maintain one or more transmission speeds of a signal (e.g., of the wireless communication) transmitting data between the wireless communications interface and the second network elements, responsive to the detection of the event. For example, the indication transmitter 330 can transmit (e.g., via antenna 228 coupled/integrated with wireless interface 222, and/or via any network elements) the signal indicating the event to application server 160, base station 110, or another component of the system.

In some implementations, the indication transmitter 330 may generate a message or notification conforming to a physical layer to resolve a false network congestion. A physical layer can be a part of the OSI model. A physical layer can execute on or include hardware, and can send data between devices through physical connections within the hardware. For example, the indication transmitter 330 may cause the wireless interface 222 to generate a MAC CE notification to cause the application server 160 to bypass anti-congestion responses/operations. In response to receiving the MAC CE notification, the application server 160 may set or configure transmission of the wireless communication to maintain normal parameters (e.g., speed or bandwidth) and/or operations.

In some implementations, the indication transmitter 330 can cause the wireless interface 222 to transmit the message or notification to the application server 160. For example, the transmission determiner 320 may determine to maintain the uplink bit rate and the indication transmitter 330 can generate a MAC CE notification/signaling indicating to maintain the uplink bit rate. The indication transmitter 330 may cause the wireless interface 222 to transmit the MAC CE notification to the application server 160. In response to the MAC CE notification indicating to maintain uplink bit rate, the application server 160 may skip or bypass congestion mitigations or inform an application layer of the application server 160 to forgo/avoid/skip/disable congestion mitigations. Congestion mitigation can include or entail performing adaptive rate control of data transmission in the communication session (e.g., by reducing data processing or transmission rate/speed, to allow congestion to subside, improve latency, etc.).

FIG. 4 depicts a diagram of a system 400 that can implement false congestion avoidance responsive to a handover event, according to an example implementation of the present disclosure. A handover event, as described herein, can occur for instance during a communication session between the UE 120 and the application server 160 (as depicted in FIG. 4; the handover event may also occur between a second UE 120 or other remote device that is generating data for use by the UE 120 and communicating the data to the UE 120 via a network that includes network elements 416, 418), or between the UE 120 and the first network element 418 or the second network element 416. A communication session can be a wireless communication or connection to transmit information, data packets, or signals between the UE 120 and a remote device (e.g., application server 160, first network element 416 or second network element 418). A handover event can be due to a lack of bandwidth, due to a change in location/mobility of the UE 120, due to a change or degradation of connection/signal quality with a current cell, due to a change of (e.g., coverage or availability of) cells of a cellular network, or due to a change in (e.g., coverage or availability of) base station (e.g., base stations 110).

The network elements 416 and 418 can include one or more of a source network, such as a cell network, a base station 110, or a radio access network (RAN). In some implementations, the network elements 416 and 418 can implement a radio access technology such as an LTE network (e.g., 4G, 5G). For example, the first network element 416 can be a source network operating on 5G and can include or be accessed via a base station 110A. For example, the second network element 418 can be a target network operating on 5G and can include or be accessed via a base station 110B. The network elements 416 and 418 can communicate or be coupled with a device including a wireless communications interface (e.g., UE 120 with interface 222). The network elements 416 and 418 can be a part of a cellular network, such as communicatively coupled to core network 170 described with reference to FIG. 1. Each network element can, in some implementations, correspond to one or more cells of the cellular network.

UE 120 can communicate with the first network element 416 and the second network element 418. In some implementations, a wireless communication or connection between the UE 120 and a remote device (e.g., application server 160) can exist (e.g., be in an operational state) and can include the first network element 416, the second network element 418, or a UPF 420. The UPF 420 can perform operations related to processing and traffic aggregation of data packets and can provide an interconnection between components of the system 400 (e.g., first network element 416, second network element 418, and application server 160). For example, the UPF 420 can be connected to the application server 160 by a link 424. For example, the UPF 420 can be connected to the first network element 416 or the second network element 418 by a link 422. Processes performed by the UPF 420 can include data packet routing, forwarding, branching (e.g., between first network 416 and second network 418, denoted by link 422), or labelling of packets. In some implementations, the indication transmitter 430 transmits the signal indicating the event and the UPF 420 processes the signal indicating the event.

In some implementations, the network elements 416 and 418 can communicate directly with a remote device (e.g., application server 160) without the UPF 420. The application server 160 can include a transport layer 414, a second protocol stack framework 412 or a second application 410. The components of the application server 160 can communicate with each other and externally, and can function interdependently or independently.

In some implementations, the second application 410 can provide protocols and parameters for communication in accordance with a TCP/IP protocol. For example, the second application 410 can standardize/implement methods of communication between the subcomponents of the server 160 and can standardize/perform communication between the server 160 and other elements (e.g., UPF 420 or UE 120). The second protocol stack framework 412 can perform functions on data such as encrypting and decrypting data or closing communication sessions. The transport layer 414 can transmit or receive data between the application server 160 and devices remote to the server (e.g., UPF 420 or UE 120) over the wireless communication or connection.

In some implementations, the wireless communication can change from the first network element 416 to a second network element 418, as depicted by a transition 426. The transition 426 from first network element 416 to second network element 418 can be an event, such as a handover. The network elements 416 and 418 can communicate with components of the UE 120. Components of the UE 120 can include a first application 402, a first protocol stack framework 404, a modem API 406, and/or an RF layer/interface 408.

The first application 402 can be similar to the second application 410, or can be used to perform operations on data generated by second application 410, including but not limited to XR operations such as presenting display data generated by the second application 410. For example, the first application 402 can standardize/implement methods of communication between the subcomponents of the UE 120 and other elements (e.g., UPF 420 or application server 160). The first protocol stack framework 404 can be similar to the second protocol stack framework 412. For example, the first protocol stack framework 404 can perform functions on data such as encrypting or decrypting data or closing communication sessions.

The modem API 406 can be an application interface for enabling the device (e.g., UE 120) to communicate with one or more networks (e.g., first network element 416 or second network element 418). For example, the modem API 406 can enable transmittal or receipt of a message (e.g., indicating a handover) from the network 416. The RF (radio frequency) layer 408 can be a subcomponent of the UE 120 which actively modulates, transmits or receives signals to other components of the system 400 (e.g., first network element 416, second network element 418, or application server 160). For example, the RF layer 408 can be coupled with an antenna (e.g., antenna 228) to transmit or receives signals.

In an illustrative example, the UE 120 can determine that a handover event 426 has occurred. The wireless communication can change/switch/transition from being between the UE 120 and the first network element 416, to being between the UE 120 and the second network element 418. The first or second network elements can transmit to the RF layer 408 a signal indicating the handover/transition. For example, the event detector 310 can detect that a handover has occurred. The RF layer 408 can relay this signal to the modem API 406 that a handover has occurred. The modem API 406 can communicate to the first protocol stack framework 404 that a handover has occurred. The modem API can (through the transmission determiner 320 and the indication transmitter 330) configure and transmit a signal indicating the event to the application server 160. In some implementations, the second protocol stack framework 412 of the application server 160 receives the signal indicating the event. The second protocol stack framework 160 then can communicate to the second application 410 that a handover has occurred. The second application 410 can indicate back to the second protocol stack framework 412 to delay or stop anti-congestion actions.

In some implementations, the modem API layer 406 can indicate to the first protocol stack framework 404 of the UE 120 that the handover event has occurred. For example, the event detector 310 can communicate through the modem API layer 406 that an event has occurred, responsive to the detection of the handover event. In some implementations, the transmission determiner 320 can modify a predetermined communication configuration layer (e.g., protocol or OSI layer). For example, the transmission determiner 320 can operate the modem API layer 406, the first protocol stack framework 404, the first application 402, or the radio frequency (RF) layer 408 of the UE 120. For example, the transmission determiner 320 can configure the signal indicating the event to include congestion feedback data indicating that the event is a handover event. For example, transmission determiner 320 can configure the signal indicating the event to include instructions to maintain a parameter of the wireless communication.

Responsive to an indication of a handover event, the second application 410 of the application server 160 can indicate to the second protocol stack framework 412 to delay/forego/skip congestion mitigation. The second protocol stack framework 412 can delay/forego/skip congestion mitigation at least according to the instructions within the signal indicating the event, or according to rules, parameters or policies pertaining to false congestion avoidance contained with the application server 160. For example, congestion mitigations can be delayed for a period of time (e.g., within milliseconds, nanoseconds), until an event (e.g., responsive to a subsequent signal indicating a normal data transmission or a signal indicating an actual congestion event) or until termination of the connection.

The application server 160 can monitor for a normal feedback. A normal feedback can be a rate of data or packet transmission which indicates that the event is completed or can be a signal from the UE 120 indicating that the event has completed (e.g., that a handover event has completed, and/or that normal communication has resumed), such as a rate that is within a threshold of a target value for normal or nominal communicate rates. A subsequent normal feedback can indicate the handover event has passed. In some implementations, the signal indicating the event (e.g., handover) can include instructions to continue ordinary transmission of the wireless communication. Ordinary transmission can refer to a remote device (e.g., the application server 160) configured to operate an application (e.g., second application 410) to generate data packets and to transmit, to the wireless communications interface (e.g., wireless interface 222), the data packets at a first speed (e.g., without implementing congestion control/mitigation), responsive to a non-congestion event.

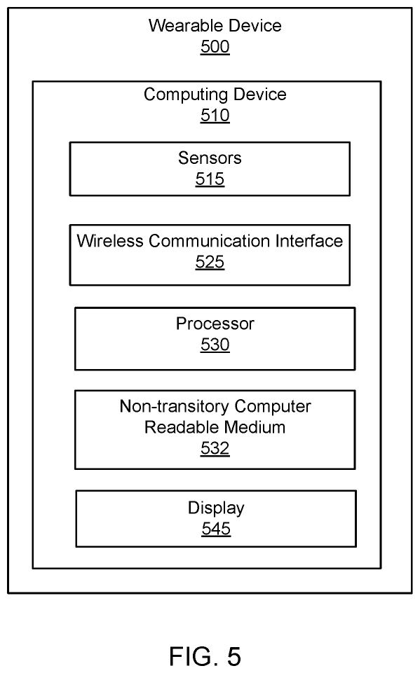

FIG. 5 is a diagram of a wearable device 500, according to an example implementation of the present disclosure. In some implementations, the wearable device 500 may be the wearable device 1110 or the wearable device 1150. In some implementations, the wearable device 500 includes a computing device 510 and a cradle (not shown in FIG. 5), to which the computing device 410 can be selectively attached. In some implementations, the computing device 510 includes sensors 515, wireless communication interfaces 525 (also referred to as “wireless interfaces 525” herein), processor 530, non-transitory computer readable medium 532, and a display 545. These components may operate together to communicate with another device, and generate or render content (e.g., artificial reality content). In other implementations, the wearable device 500 includes more, fewer, or different components than shown in FIG. 5.

In some implementations, the sensors 515 include electronic components or a combination of electronic components and software components that detect a proximity of a user wearing the wearable device 500. For example, the sensors 515 can include a hall sensor that can detect whether the user is proximate (e.g., less than 10 mm) to the sensor or whether the user is contacting the computing device 510 (e.g., contacting and/or blocking a certain component of the device used/configured for wireless communication). The sensors 515 may detect a proximity of the user with respect to the computing device 510, and can generate a sensor measurement data indicating the detected proximity.

In some implementations, the sensors 515 include electronic components or a combination of electronic components and software components that can operate to sense/determine/measure a location and/or an orientation of the computing device 510. Examples of the sensors 515 can include: one or more imaging sensors, one or more accelerometers, one or more gyroscopes, one or more magnetometers, or any other suitable type of sensor(s) that detects motion and/or location. For example, one or more accelerometers can measure translational movement (e.g., forward/back, up/down, left/right) and one or more gyroscopes can measure rotational movement (e.g., pitch, yaw, roll). In some implementations, the sensors 515 detect the translational movement and the rotational movement, and determine an orientation and location of the computing device 510. The sensors 515 may generate sensor measurements indicating the detected location and orientation of the computing device 510.

In some implementations, wireless communication interfaces 525 include electronic components or combinations of electronic components and software components that communicate with another device through wireless communication links (e.g., communication link 1114, 1116, 1118). In some implementations, the wireless communication interfaces 525 include a wireless interface for a cellular communication link (e.g., 3G, 4G, LTE communication link). The wireless communication interfaces 525 may also include a wireless interface for a different communication link (e.g., Wi-Fi or Bluetooth communication link). In some implementations, wireless communication interfaces 525 include or are embodied as transceivers or communication modems coupled to the transceivers for transmitting and receiving data through wireless mediums. The wireless communication interfaces 525 may transmit or receive sensor measurement data indicating locations and orientations of the computing device 510. Moreover, the wireless communication interface 525 may transmit or receive image data indicating or corresponding to images to be rendered.

In some implementations, the processor 530 includes an electronic component or a combination of an electronic component that can execute instructions stored by the non-transitory computer readable medium 532. The processor 530 may include one or more central processing units (CPUs), graphical processing units (GPUs) or a combination of them. The non-transitory computer readable medium 532 may store instructions for executing one or more applications executable by the processor 530.

One example application when executed by the processor 530 may cause the processor 530 to generate or process content for rendering. The processor 530 executing the application may cause the processor 530 to generate image data for rendering, according to sensor measurement data from the sensors 515 or the wireless communication interfaces 525. For example, the processor 530 executing the application may determine a view of the artificial reality corresponding to detected location and orientation in the sensor measurement data and generate image data of the determined view of the artificial reality.

Example applications when executed by the processor 530 may cause the processor 530 to control or adjust the wireless communication interface 525. Example applications include wireless interface controller 534.

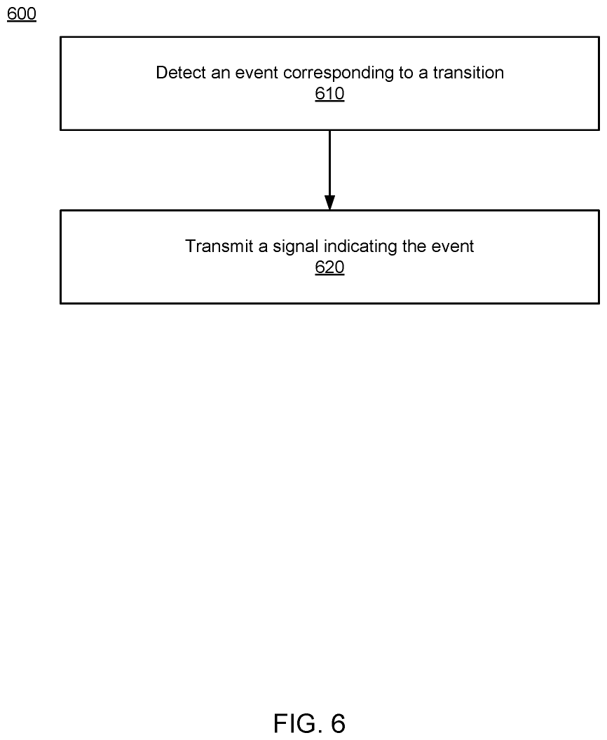

FIG. 6 depicts a flowchart 600 showing a method of false congestion avoidance, according to an example implementation of the present disclosure. The method 600 can include act 610, wherein the system can detect an event corresponding to a transition, and act 620, wherein the system can transmit a signal indicating the event. The method 600 can include more or fewer acts than those described herein.

At act 610, the system can detect an event corresponding to a transition. A transition can refer to an event such as a handover or a non-congestion event. Act 610 can include detecting, by one or more processors, an event corresponding to a transition of at least one wireless connection, from being between the wireless communications interface and a first network element, to being between the wireless communications interface and a second network element. For example, the event detector 310 can detect an event corresponding to a transition, such as a handover.

Detecting the event can be responsive to an indication from a modem of the wireless communications interface wherein the indication is a signal corresponding to a non-congestion event. The modem can be/include modem API 406. In some implementations, modem API 406 can execute on the wireless interface 222 of the UE 120. The first network element 116, the second network element 118, or the UPF 420 can transmit the signal corresponding to the non-congestion event. A non-congestion event can be a handover event.

At act 620, the system can transmit a signal indicating the event. For example, the transmission determiner 320 can configure a signal to include data, packets, or information pertaining to the event. The indication transmitter 330 can transmit the signal indicating the event. Act 620 can include transmitting, by the one or more processors (e.g., transmission determiner 320 or indication transmitter 330), to a remote device (e.g., application server 160) coupled with the wireless communications interface (e.g., wireless interface 222) via the second network element (e.g., second network element 118), a signal indicating the event. In some implementations, the signal can be an indication, the indication including instructions, controls, or commands to maintain one or more transmission speeds of a signal transmitting data between the wireless communications interface and the second network elements, responsive to the detection of the event. In some implementations, the signal can include congestion feedback data. Congestion feedback data can be information about data packets (e.g., speed, quantity, size), bandwidth of the wireless communication, or delay times, which can be sent to the remote device during handover or other portions of a communication session, and/or be in response to real or potential congestion of traffic in the communication session.

The method 600 can include operating, by the remote device, an application to generate data packets. For example, second application 410 can generate data packets. The method 600 can further include transmitting, by the remote device (e.g., application server 160), to the wireless communications interface (e.g., wireless interface 222), the data packets at a first speed, responsive to a non-congestion event (e.g., a handover/transition event during which or as a result of which any perceived congestion may not be real or should not be addressed/mitigated). For example, responsive to receiving the signal from the UE 120 indicating the event, the application server 160 can instruct the second application 410 to generate data packets for transmittal to the UE 120 via the wireless communication at a certain speed (e.g., for operation in the absence of traffic congestion).

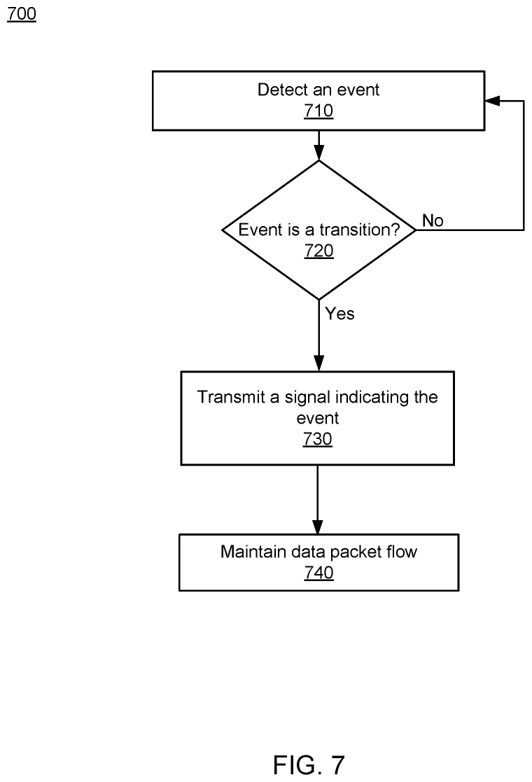

FIG. 7 depicts an example flowchart 700 showing a method of event detection. The flowchart 700 can include act 710, wherein the system detects an event, act 720, wherein the system determines if the event is a transition/handover, act 730, wherein the system transmits a signal indicating the event, and act 740, wherein the system maintains data packet flow. The flowchart can include more or fewer acts than those depicted herein and is meant to be exemplary.

At act 710, the system detects an event. The system (e.g., part of a UE, application server, network element and/or core network) can detect can event, for example, by event detector 310. For example, event detector 310 can detect an event at least responsive to an indication from the second network element 118, to a change in data packet speed, or to a change in network parameters.

At act 720, the system can determine if the event is a transition. A transition can be an event such as a handover, wherein the wireless communication changes from being between a wireless interface (e.g., wireless interface 222 of UE 120) and a first network element (e.g., first network element 416) to being between a wireless interface and a second network element (e.g., second network element 418). The event being a transition can be determined, for example, by event detector 310. Responsive to a determination that an event is not a transition (e.g., handover event), the system can refer back to act 710 to monitor, detect, or identify an event. Responsive to a determination that the event is a transition, the flow 700 can proceed to act 730.

At act 730, the system can transmit a signal indicating the event. Transmitting a signal indicating the event can refer to configuring, by the transmission determiner 320, a signal to include data, information, or packets indicating the event. The signal indicating the event can include an indication of the event, an acknowledgement of receipt of data packets from the remote device (e.g., application server 160), instructions for the remote device pertaining to transmission parameters such as speed, bandwidth, or frequency, or a message to any of the components of the system (e.g., second network element 416, application server 160, or UPF 420). Transmitting a signal indicating the event can further include the indication transmitter 330 transmitting the signal indicating the event through, for example, the modem API 406, the first protocol stack framework 404, or the antenna 228. Transmitting the signal indicating the event can occur concurrently with receipt of a wireless communication, a second signal, or other signals occurring in the system. Transmitting the signal can further include congestion feedback data.

At act 740, the system can maintain data packet flow (e.g., for operation in the absence of traffic congestion, and/or by forgoing congestion mitigation). For example, data packet flow of a communication between the UE 120 and second network element 418, or between the UE 120 and the application server 160 can include a transmission of data packets. The data packets can be created by the application server 160 for transmission to the UE 120, or by the UE 120 for transmission to the application server 160. The data packets can be transmitted over a wireless communication between the UE 120 and the application server 160. Maintaining data packet flow can include maintaining/supporting/implementing/providing a speed, bandwidth, frequency, or other parameter of signal transmission (e.g., without adjustment/control of one or more of the foregoing to perform mitigation of traffic congestion).

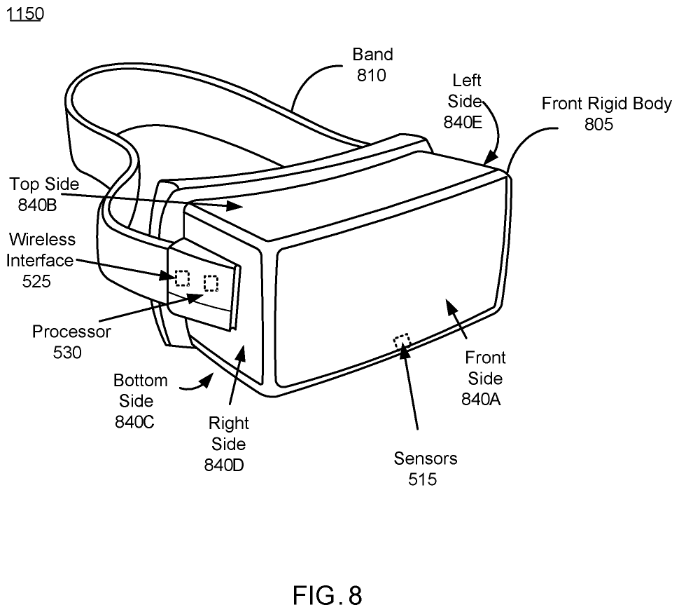

FIG. 8 is a diagram of the HWD 1150, in accordance with an example implementation. In some implementations, the HWD 1150 includes a front rigid body 805 and a band 810. The front rigid body 805 includes the display 545 (not shown in FIG. 8), lens (not shown in FIG. 8), the sensors 515, the wireless communication interface 525, and the processor 530. In the implementation shown by FIG. 8, the wireless communication interface 525, the processor 530, and the sensors 515 are located within the front rigid body 805, and may not be visible to the user. In other implementations, the HWD 1150 has a different configuration than shown in FIG. 8. For example, the wireless communication interface 525, the processor 530, and/or the sensors 515 may be in different locations than shown in FIG. 8.

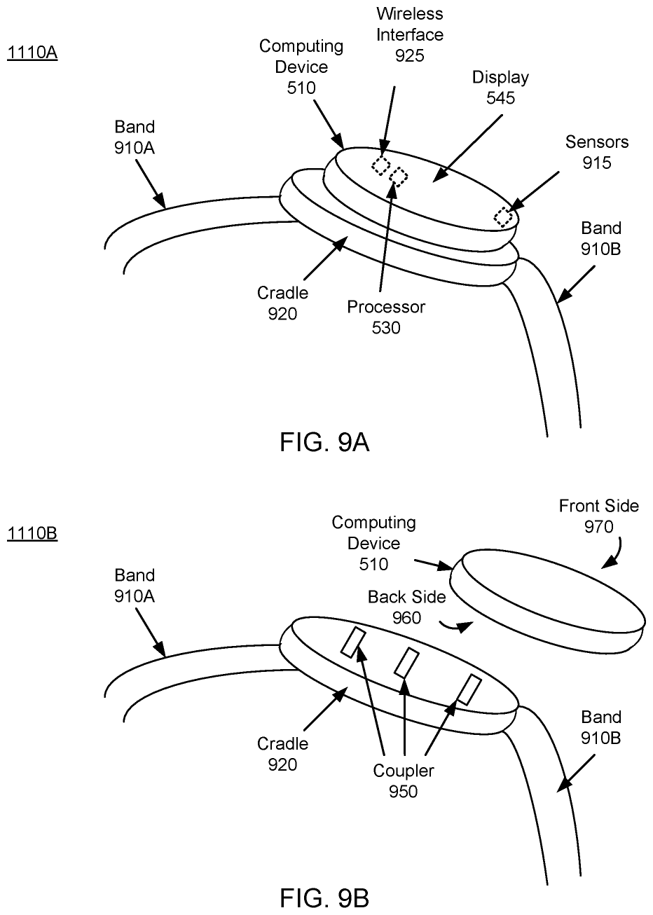

FIG. 9A is a diagram showing a perspective view of the wearable device 1110A (e.g., wearable device 1110 in a state 1110A) including a computing device 510 attached to a cradle 920, according to an example implementation of the present disclosure. The processor 530, the wireless communication interface 525 and the sensors 515 may be disposed within a housing of the computing device 510, such that the processor 530, the wireless communication interface 525 and the sensors 515 may not be visible to the user. The computing device 510 may also include the display 545 on a front side 970 to present text or image. The computing device 510 may be detachable from the cradle 920 as shown in FIG. 9B (e.g., wearable device 1110 in state 1110B). The computing device 510 may be detached from the cradle 920 to allow the user to charge the battery of the computing device 510, connect to another device through a cable, or capture an image, etc. The cradle 920 may be a wearable structure or a component to selectively hold, contain, connect, grasp and/or couple the computing device 510. The cradle 920 may include one or more couplers 950, to which a back side 960 or other portion of the computing device 510 can be attached. One or more couplers 950 may include mechanical latches, magnetics, hook and loop fasteners, or any component(s) that allow the cradle 920 to selectively hold or couple the computing device 510. The cradle 920 may include or may be attached to wrist bands 910A, 920B.

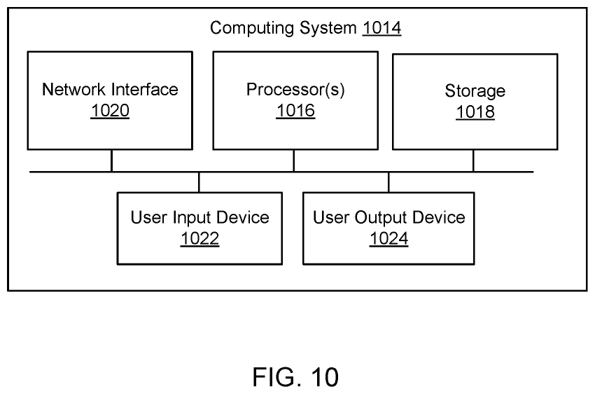

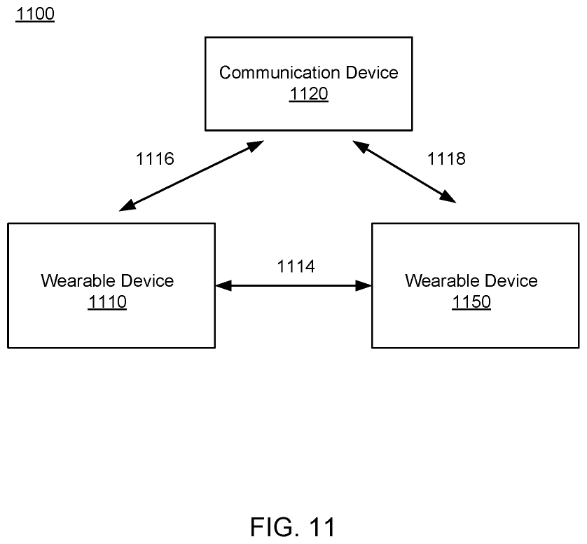

Various operations described herein can be implemented on computer systems. FIG. 10 shows a block diagram of a representative computing system 1014 usable to implement implementations of the present disclosure. In some implementations, the wearable device 1110 of FIG. 11 is implemented by the computing system 1014. The computing system 1014 can be implemented, for example, as a consumer device such as a smartphone, other mobile phone, tablet computer, wearable computing device (e.g., a smart watch, eyeglasses, a head wearable display), desktop computer, laptop computer, or implemented with distributed computing devices. The computing system 1014 can be implemented to provide VR, AR, MR experience. In some implementations, the computing system 1014 can include conventional computer components such as processors 1016, storage device 1018, network interface 1020, user input device 1022, and user output device 1024.

The network interface 1020 can provide a connection to a wide area network (e.g., the Internet) to which WAN interface of a remote server system is also connected. The network interface 1020 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The user input device 1022 can include any device (or devices) via which a user can provide signals to the computing system 1014, which can interpret the signals as indicative of particular user requests or information. The user input device 1022 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

The user output device 1024 can include any device via which the computing system 1014 can provide information to a user. For example, the user output device 1024 can include a display (not depicted) to display images generated by or delivered to the computing system 1014. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that functions as both input and output device can be used. The user output devices 1024 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this disclosure can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, the processors 1016 can provide various functionality for the computing system 1014, including any of the functionality described herein as being performed by a server or client, or other functionality associated with message management services.

It will be appreciated that the computing system 1014 is illustrative and that variations and modifications are possible. Computer systems used in connection with the present disclosure can have other capabilities not specifically described here. Further, while the computing system 1014 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

FIG. 11 is a block diagram of an example system 1100. In some implementations, the system 1100 includes a communication device 1120, a wearable device 1110, and a wearable device 1150. The wearable device 1110 may be a smart watch, and the wearable device 1150 may be a head wearable device (HWD) 1150. The communication device 1120 may be an access point or any other communication device. The HWD 1150 may be referred to as, include, or be part of a head mounted display (HMD), head mounted device (HMD), head worn display (HWD) or head worn device (HWD). The wearable device 1110 and the HWD 1150 may communicate with each other through a communication link 1114. The wearable device 1110 and the communication device 1120 may communicate with each other through a communication link 1116, and the wearable device 1150 and the communication device 1120 may communicate with each other through a communication link 1118. Through the wireless links 1116, 1118, the wearable devices 1110, 1150 may access content (e.g., text, image, audio, video, etc.) from other devices. The communication links 1114, 1116, 1118 may be wireless links (e.g., cellular link, Wi-Fi link, Bluetooth link, 60 GHz link, ultra wideband link, etc.). The communication links 1114, 1116, 1118 may be based on the same protocol or different protocols. For example, the communication links 1116, 1118 may conform to the 3G, 4G, 5G, LTE, 60 GHz protocol, where the communication link 1114 may conform to the Wi-Fi link, Bluetooth, etc. In some implementations, the system 1100 includes more, fewer, or different components than shown in FIG. 11.

In one aspect, the wearable device 1110 and the wearable device 1150 may operate together to provide/support artificial reality for a user. In one example, the wearable device 1150 may detect a location and an orientation of the wearable device 1150, and generate a sensor measurement indicating the detected location and orientation of the wearable device 1150. The wearable device 1150 may transmit the sensor measurement to the wearable device 1110 through the communication link 1114. The wearable device 1110 may receive the sensor measurement, and may generate or determine a view of the artificial reality corresponding to the detected location and orientation of the wearable device 1150. The wearable device 1110 may generate image data of the determined view of the artificial reality, and transmit the image data to the wearable device 1150 through the communication link 1114. The HWD 1150 may receive the image data, and can present an image of the artificial reality to a user according to the image data. In one aspect, the process of detecting the location and the orientation of the HWD 1150, and rendering the image to the user should be performed within a frame time (e.g., 11 ms or 16 ms). Any latency between a movement of the user wearing the HWD and an image displayed corresponding to the user movement can cause judder, which may result in motion sickness and can degrade the user experience.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary implementations, and that such variations are intended to be encompassed by the present disclosure.

What is claimed is:

1. A device, comprising:
a wireless communications interface; and
one or more processors to:
detect an event corresponding to a transition of at least one wireless connection, from being between the wireless communications interface and a first network element, to being between the wireless communications interface and a second network element; and
transmit, via the wireless communication interface to a remote device, a signal comprising at least one of: an indication of the event or an indication to avoid a congestion mitigation operation.

2. The device of claim 1, wherein the one or more processors are further configured to:
transmit, to the remote device, an indication to maintain one or more rates of data transmission between the wireless communications interface and the remote device, responsive to the detection of the event.

3. The device of claim 1, wherein the signal comprises congestion feedback data.

4. The device of claim 1, wherein the indication causes the remote device to maintain one or more rates of data transmission.

5. The device of claim 1, wherein the remote device is a server, the server configured to:
execute an application to generate data packets; and
transmit, to the wireless communications interface, the data packets at a first rate of data transmission, in the absence of a congestion event.

6. The device of claim 1, wherein the network elements are cells or base stations of a cellular network.

7. The device of claim 1, wherein the one or more processors are further configured to:
detect the event responsive to an indication from a modem of the wireless communications interface, wherein the indication is indicative of a handover event or a non-congestion event.

8. The device of claim 1, wherein one or more processors are configured to:
execute a predetermined protocol layer; and
generate, at the predetermined protocol layer, the signal.

9. The device of claim 1, wherein the one or more processors are configured to transmit the signal according to a predetermined communication protocol, the predetermined communication protocol providing for:
transmitting the signal via at least one packet, an indication of the transition, to the remote device; and
cause the remote device to determine or implement a response to the transition.

10. The device of claim 1, wherein the one or more processors are configured to transmit the signal according to a predetermined communication protocol, the predetermined communication protocol providing for:
transmitting the signal via an acknowledgement of receipt of one or more data packets from the remote device, an indication of the transition, to the remote device; and
cause the remote device to determine or implement a response to the transition.

11. The device of claim 1, wherein the event comprises a handover event between a target cell and a source cell.

12. A method, comprising:
detecting, by a device, an event corresponding to a transition of at least one wireless connection, from being between a wireless communications interface of the device and a first network element, to being between the wireless communications interface and a second network element;
transmitting, by the device via the wireless communications interface, to a remote device, a signal comprising at least one of: an indication of the event or an indication to avoid a congestion mitigation operation.

13. The method of claim 12, wherein the method further comprises:
transmitting, to the remote device, an indication to maintain one or more rates of data transmission between the wireless communications interface and the remote device, responsive to the detection of the event.

14. The method of claim 12, wherein the signal indicating the event comprises congestion feedback data.

15. The method of claim 12, further comprising:
executing, by the remote device, an application to generate data packets; and
transmitting, to the wireless communications interface, the data packets at a first rate of data transmission, in the absence of a congestion event.

16. The method of claim 12, further comprising:
detecting, by the device, the event responsive to an indication from a modem of the wireless communications interface wherein the indication is indicative of a handover event or a non-congestion event.

17. The method of claim 12, further comprising:
executing, by the device, a predetermined protocol layer; and
generating, by the predetermined protocol layer, the signal.

18. The method of claim 12, further comprising transmitting, by the device, the signal according to a predetermined communication protocol, the predetermined communication protocol providing for:
transmitting the signal via at least one packet, an indication of the transition, to the remote device; and
cause the remote device to determine or implement a response to the transition.

19. The method of claim 12, further comprising transmitting, by the device, the signal according to a predetermined communication protocol, the predetermined communication protocol providing for:
transmitting the signal via an acknowledgement of receipt of one or more data packets from the remoted device, an indication of the transition, to the remote device; and
cause the remote device to determine or implement a response to the transition.

20. A non-transitory computer readable medium storing program instructions for causing at least one processor of a device to:
detect an event corresponding to a transition of at least one wireless connection, from being between the wireless communications interface and a first network element, to being between the wireless communications interface and a second network element;
transmit, via the wireless communication interface to a remote device, a signal comprising at least one of: an indication of the event or an indication to avoid a congestion mitigation operation.
